(19) United States
(12) Patent Application Publication
(10) Pub. No.: US 2019/0186976 A1
(43) Pub. Date: Jun. 20, 2019

(54) LEVEL MARKER ISOLATION TYPE OIL LEVEL GAUGE

(71) Applicants: Hyundai Motor Company, Seoul (KR); Kia Motors Corporation, Seoul (KR)

(72) Inventor: Jae-Seung Baek, Seoul (KR)

(21) Appl. No.: 16/156,192

(22) Filed: Oct. 10, 2018

(30) Foreign Application Priority Data
Dec. 15, 2017 (KR) 10-2017-0172924

(51) Int. Cl. G01F 23/04

(52) U.S. Cl. CPC G01F 23/04

(57) ABSTRACT

An oil level gauge is provided. The gauge includes a gauge plate that is coupled to a knob. The gauge plate has a mark isolation body, a level mark body, and a gauge end body, which are connected from a gauge fixture body. The mark isolation body and the gauge end body have a phase difference by a two-stage twisted section for the level mark body having L (LOW) and F (FULL) marks indicative of an oil capacity. Accordingly, the visibility of the level mark body is maintained clean by preventing the L (LOW)/F (FULL) mark of the level mark body from being contaminated with wall surface oil when the gauge plate is pulled out from a gauge channel path of an engine.

### CROSS-REFERENCE(S) TO RELATED APPLICATIONS

This application claims priority to Korean Patent Application No. 10-2017-0172924, filed on Dec. 15, 2017 which is incorporated herein by reference in its entirety.

### BACKGROUND

### Field of the Invention

The present invention relates to an oil level gauge; and, more particularly, to an oil level gauge that prevents oil contamination of a level marker.

### Description of Related Art

In general, an oil level gauge is an instrument used to prevent damage to an engine or a transmission due to insufficient lubrication caused by insufficient oil supply. For example, damage may be caused when the oil level gauge is pulled out during a vehicle inspection to directly check the level of oil in the engine or the transmission to the naked eye. Particularly, the oil level gauge includes a knob exposed out of the engine to be gripped by a worker's hand, and an elongated flat gauge plate fitted to the engine while having a portion soaked in oil. To check the level of oil, an L (LOW) mark (minimum oil level mark) and an F (FULL) mark (maximum oil level mark) are formed spaced apart from each other at the surface of the gauge plate.

Accordingly, the oil level gauge allows a current level of oil to be checked by pulling out the gauge plate coated with the oil from the engine and then checking the L mark or the F mark, at which the oil coating the gauge plate is positioned. Therefore, the oil level gauge significantly contributes to determining a time for replenishing an appropriate amount of oil to prevent engine damage.

However, the oil level gauge includes the elongated gauge plate having a structure in which the end thereof is set as a 90° twisted gauge end and the total length thereof is set as a flat straight level mark section, and the L mark and the F mark are spaced apart from each other in the level mark section. Thus, the gauge plate is scratched on the wall surfaces of a lower crankcase and an engine block when the worker pulls out the oil level gauge from the engine, and the scratch causes the coating of the level mark section with oil, thereby causing the periphery of the L and F marks to be contaminated with oil.

Accordingly, it is impossible to check a level of oil since the L mark and the F mark are invisible due to the oil contamination in the level mark section, even though the oil level gauge is pulled out from the engine to check a current level of oil. Particularly, considering the structure in which the oil level gauge is installed using a narrow gauge channel path in the engine, it is impossible to prevent oil contamination due to the scratch of the gauge plate on the wall surface even though the worker carefully pulls out the oil level gauge.

### SUMMARY

The present invention is directed to a level marker isolation type oil level gauge capable of maintaining visibility of a level marker clean by preventing the level marker from being contaminated with oil scraped from a wall surface while the oil level gauge is pulled out, particularly of having a simplified structure by forming a level mark section isolated between twisted sections to block contact and scratch causing oil contamination.

Other objects and advantages of the present invention may be understood by the following description, and become apparent with reference to the exemplary embodiments of the present invention. Additionally, it is obvious to those skilled in the art to which the present invention pertains that the objects and advantages of the present invention may be realized by the means as claimed and combinations thereof.

In accordance with an exemplary embodiment of the present invention, an oil level gauge may include a gauge plate having a two-stage twisted section formed for a level mark body connected from a gauge fixture body, the level mark body having L (LOW) and F (FULL) marks indicative of an oil capacity. The two-stage twisted section may be formed at each of a mark isolation body for connecting the gauge fixture body to the level mark body, and a gauge end body connected to the level mark body. The mark isolation body and the gauge end body may have a phase difference of about 90° with respect to the gauge fixture body and the level mark body by twisting.

The level mark body may have a greater length than the mark isolation body and the gauge end body. A mark isolation section forming the length of the mark isolation body may be longer than a gauge end section forming the length of the gauge end body. The L (LOW) and F (FULL) marks of the level mark body may be distinguished by protrusions. The gauge plate may be coupled to a knob gripped by a user's hand, and the knob may be coupled with a sealing ring. The gauge plate may be coupled to an engine, and the L (LOW) and F (FULL) marks of the level mark body may indicate a level of engine oil. The engine may have a gauge channel path defined by an engine block and a lower crankcase to allow the gauge plate to be fitted in the gauge channel path.

### BRIEF DESCRIPTION OF THE DRAWINGS

FIG. 1 is a schematic view illustrating a level marker isolation type oil level gauge according to an exemplary embodiment of the present invention;

FIG. 2 is a schematic view illustrating a gauge end section and a level mark section of the oil level gauge according to the exemplary embodiment of the present invention;

FIG. 3 is a view illustrating an example in which the level marker isolation type oil level gauge according to the exemplary embodiment of the present invention is applied to an engine;

FIG. 4 is a view illustrating a state in which the oil level gauge according to the exemplary embodiment of the present invention is pulled out from a gauge channel path in the engine; and

FIG. 5 is a view illustrating visibility of a level marker after the oil level gauge according to the exemplary embodiment of the present invention is pulled out from the engine.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Exemplary embodiments of the present invention will be described below in more detail with reference to the accompanying drawings. The present invention may, however, be embodied in different forms and should not be construed as limited to the exemplary embodiments set forth herein. Rather, these exemplary embodiments are provided so that this disclosure will be thorough and complete, and will fully convey the scope of the present invention to those skilled in the art. Throughout the disclosure, like reference numerals refer to like parts throughout the various figures and exemplary embodiments of the present invention.

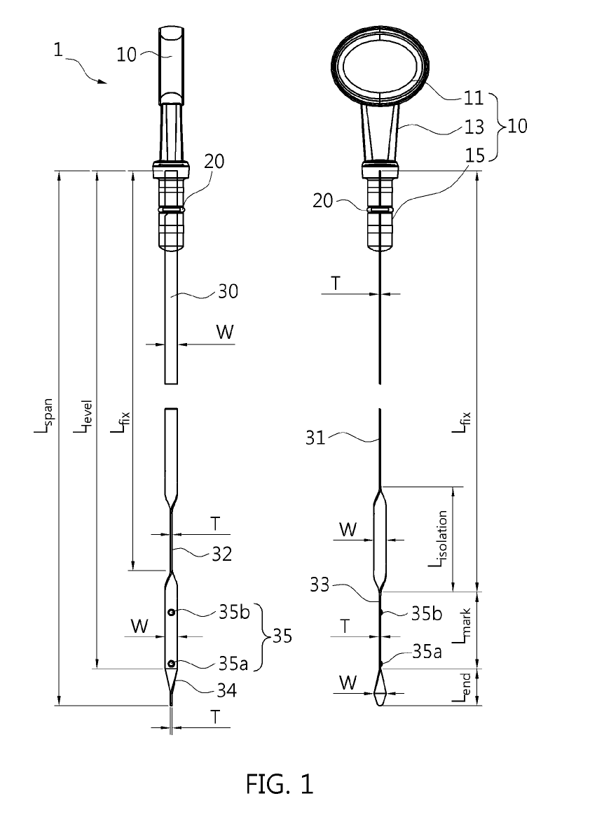

Referring to FIG. 1, an oil level gauge 1 may include a knob 10, a sealing ring 20, and a gauge plate 30. The gauge plate 30 may have a two-stage twisted section formed for an oil level mark 35 to maintain the visibility of a level maker (e.g., L/F mark) clear by preventing oil contamination thereof even when the oil level gauge is pulled out from an engine. Accordingly, the oil level gauge 1 is implemented as a level marker isolation type oil level gauge.

In particular, the knob 10 is a portion gripped by a user's hand, and may include a handle 11, an extension portion 13, and a fastening portion 15. The handle 11 may be shaped ergonomically such that it may be comfortably gripped by the user's hand, and the extension portion 13 and the fastening portion 15 extend from the handle 11. The extension portion 13 may have a protruding edge formed at the end thereof for distinguishing from the fastening portion 15, and the protruding edge allows for fixing force in the state in which it is fitted to any other part (e.g., an engine). Particularly, the protruding edge may have a thread formed on the outer peripheral surface thereof to be screwed instead of being fitted. The fastening portion 15 may include a groove formed at the immediate position thereof to fit the sealing ring 20 in the groove.

Additionally, the sealing ring 20 may be made of rubber or urethane and forms a sealing when fitted in the groove of the fastening portion 15 and may be fitted to any other part (e.g., an engine). The gauge plate 30 may have a substantially thin elongated plate shape, and may include a gauge fixture body 31, a mark isolation body 32, a level mark body 33, and a gauge end body 34 in the total section thereof.

Structurally, the gauge fixture body 31 forms a straight section, and may be press-fitted in the axial aperture of the fastening portion 15 for integration with the knob 10. The level mark body 33 forms a straight section, and may include an oil level mark 35 that indicates an engine oil capacity. The mark isolation body 32 forms a straight section for connecting the gauge fixture body 31 to the level mark body 33 while allowing the gauge plate 30 to have a single-stage twisted section formed by twisting the gauge fixture body 31 and the level mark body 33. Further, the gauge end body 34 forms a straight section connected to the level mark body 33 while allowing the gauge plate 30 to have a two-stage twisted section formed by twisting the level mark body 33. The oil level mark 35 may include an L mark protrusion 35a and an F mark protrusion 35b, which protrude in a hemispheric form from the surface of the level mark body 33, in which case the L mark protrusion 35a is a line marking the minimum (LOW) capacity of the oil level gauge 1 with LOW and the F mark protrusion 35b is a line marking the maximum (FULL) capacity of the oil level gauge 1 with FULL.

As a result, when viewing the oil level gauge 1 from the front as in the front view of FIG. 1, the width (W) of the gauge plate 30 is checked by the gauge fixture body 31 and the level mark body 33, whereas the thickness (T) thereof is checked by the mark isolation body 32 and the gauge end body 34. In addition, when viewing the oil level gauge 1 from the side as in the side view of FIG. 1, the width (W) of the gauge plate 30 is checked by the mark isolation body 32 and the gauge end body 34, whereas the thickness (T) thereof is checked by the gauge fixture body 31 and the level mark body 33.

In terms of layout, assuming that the overall gauge length (Lₛₚₐₙ) of from the gauge fixture body 31 to the gauge end body 34 is about “1” in the gauge plate 30, the fixed gauge length ratio (L_{fix}) from the gauge fixture body 31 to the mark isolation body 32, the gauge level length ratio (Lₗₑᵥₑₗ) from the gauge fixture body 31 to the level mark body 33, the mark isolation length ratio (Lᵢₛₒₗₐₜᵢₒₙ) the mark isolation body 32, the level mark length ratio (Lₘₐᵣₖ) of the level mark body 33, and the gauge end length ratio (L_{end}) of the gauge end body 34 may be as the follows:

fixed gauge length ratio (L_{fix}): about 0.88-0.89

gauge level length ratio (Lₗₑᵥₑₗ): about 0.95-0.97

mark isolation length ratio (Lᵢₛₒₗₐₜᵢₒₙ): about 0.043-0.045

level mark length ratio (Lₘₐᵣₖ): about 0.05-0.06, and

gauge end length ratio (L_{end}): about 0.027-0.028.

On the other hand, assuming that the level mark section (Lₘₐᵣₖ) as a length of the level mark body 33 is “1”, the mark isolation section (Lᵢₛₒₗₐₜᵢₒₙ) as a length of the mark isolation body 32 and the gauge end section (L_{end}) as a length of the gauge end body 34 may be as the follows:

mark isolation section (Lᵢₛₒₗₐₜᵢₒₙ): about 0.8, and

gauge end section (L_{end}): about 0.5.

Each scale of the fixed gauge length (L_{fix}), the gauge level length (Lₗₑᵥₑₗ), the mark isolation section (Lᵢₛₒₗₐₜᵢₒₙ), the level mark section (Lₘₐᵣₖ), and the gauge end section (L_{end}) may be set considering physical properties of engine oil (e.g., viscosity) to delay the flow of oil, which is scraped due to the contact of the gauge plate 30 pulled out under the condition where no two-stage twisted section is formed, from the mark isolation body 32 to the level mark body 33.

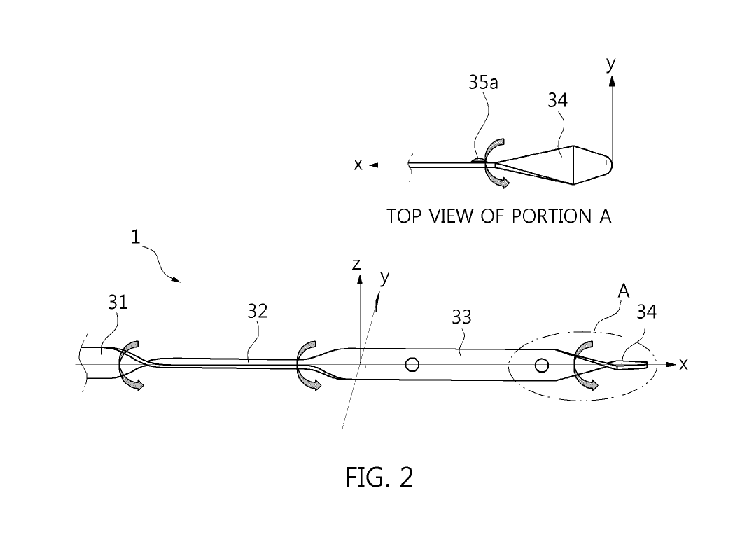

Referring to FIG. 2, the gauge plate 30 may form a phase difference between the phase of the gauge fixture body 31 and the level mark body 33 and the phase of the mark isolation body 32 and the gauge end body 34 in x-y-z coordinates by the two-stage twisted section. For example, the phase difference may be 90°. In particular, the phase difference of 90° allows the visibility of the L mark protrusion 35a and the F mark protrusion 35b to be maintained by preventing the oil contamination of the oil level mark 35 of the level mark body 33 even when the oil level gauge 1 is pulled out from the engine.

Therefore, the oil barrier effect of the oil level gauge 1 for preventing oil flowing down along the gauge plate 30 from being coated on the level mark body 33 is significantly improved by the synergy of the length scales of the mark isolation body 32 and the level mark body 33a, as a basic effect, and the two-stage twisted section as a direct effect.

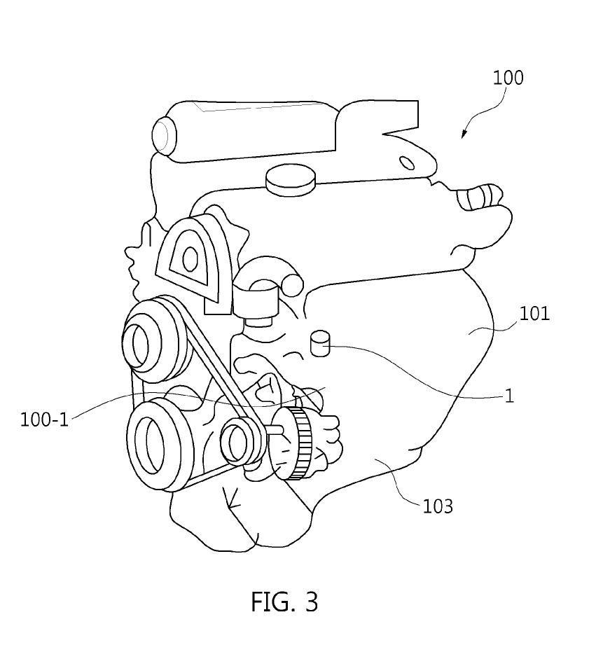

Meanwhile, FIGS. 3 to 5 illustrate an example in which the level marker isolation type oil level gauge 1 is applied to an engine. Referring to FIG. 3, an engine 100 may include an engine block 101 and a lower crankcase 103 to which the oil level gauge 1 is coupled. The oil level gauge 1 is the level marker isolation type oil level gauge 1 described with reference to FIGS. 1 and 2. However, a gauge channel path 100-1 may be sealed by the sealing ring 20 of the oil level gauge 1.

Particularly, the engine block 101 may include a cylinder block having cylinders in which combustion occurs by pistons, a cylinder head coupled to the upper portion of the cylinder block while having a cam and a valve system, and an oil fan disposed in the lower portion of the cylinder block while storing engine oil circulating the engine 100. The lower crankcase 103 may be mounted to the lower portion of the engine block 101 to protect and surround the lower portion of a crankshaft. Therefore, the engine 100 equipped with the engine block 101 and the lower crankcase 103 is a typical internal combustion engine.

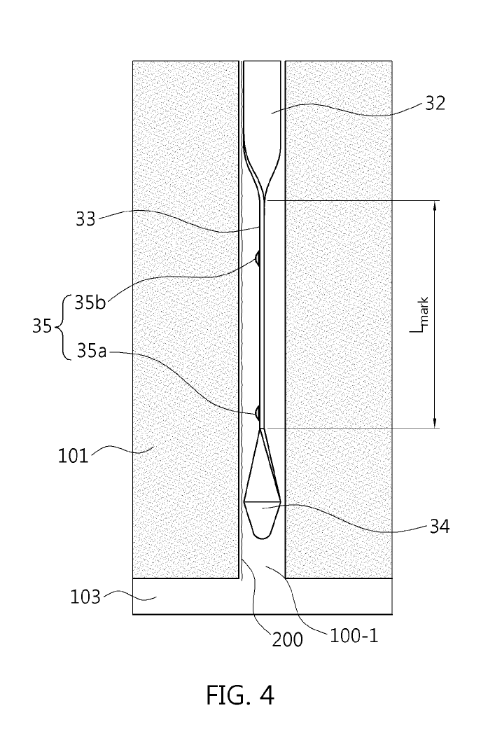

Referring to FIG. 4, the engine block 101 and the lower crankcase 103 define the gauge channel path 100-1 in which the oil level gauge 1 is fitted. Thus, since the oil level gauge 10 is pulled out from the gauge channel path 100-1 to be separated from the engine 100 when the knob 10 is gripped and a force is applied thereto, it may be possible to inspect the engine oil.

Accordingly, the gauge plate 30 may come into contact with the wall surface of the gauge channel path 100-1 in the process of pulling out the oil level gauge 1 from the engine, which may lead to the scraping of wall surface oil 200 due to the gauge plate 30. Therefore, the mark isolation body 32 comes into contact with the gauge channel path 100-1 in the process of pulling out the gauge plate 30 from the gauge channel path 100-1, and the wall surface oil 200 scraped due to the contact is coated on the mark isolation body 32.

However, the layout of the gauge plate 30 is formed such that, when the gauge plate 30 is positioned in the gauge channel path 100-1 while having the two-stage twisted section, the mark isolation body 32 and the gauge end body 34 occupies the internal space of the gauge channel path 100-1 in the width (W) direction thereof whereas the gauge fixture body 31 and the level mark body 33 do not occupy the internal space of the gauge channel path 100-1 in the thickness (T) direction thereof. As a result, the level mark body 33 having the level mark section (Lₘₐᵣₖ) between the mark isolation body 32 and the gauge end body 34 is prevented from scraping the wall surface oil 200 since it does not come into contact with the gauge channel path 100-1. This non-contact continues until the gauge end body 34 is completely pulled out from the gauge channel path 100-1. Therefore, it may be possible to prevent the level mark body 33 from being coated with the wall surface oil 200 which thus allows the marker to be continuously visible to check the oil level.

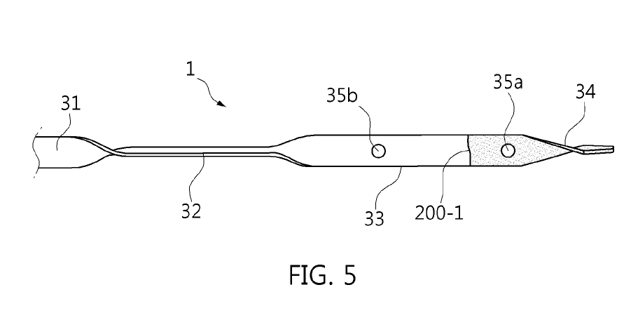

FIG. 5 illustrates an example of the gauge plate 300 that is completely pulled out from the gauge channel path 100-1 without the scraping of the wall surface oil on the level mark body 33. As illustrated in the drawing, since the level mark body 33 of the gauge plate 30 is maintained clean in the state in which it is not contaminated with the wall surface oil 200, it may be possible to more easily check gauge oil 200-1 coated on the L mark protrusion 35a of the oil level mark 35.

As described above, the oil level gauge 1 according to the exemplary embodiment of the present invention may include the gauge plate 30 coupled to the knob 10, the gauge plate 30 may include the mark isolation body 32, the level mark body 33, and the gauge end body 34, which are connected from the gauge fixture body 31, and the mark isolation body 32 and the gauge end body 34 have a phase difference by the two-stage twisted section for the level mark body 33 having the L (LOW) mark and the F (FULL) mark, which indicate an oil capacity, thereby maintaining the visibility of the level mark body 33 clean by preventing the L (LOW)/F (FULL) mark of the level mark body 33 from being contaminated with the wall surface oil 200 when the gauge plate 30 is pulled out from the gauge channel path 100-1 of the engine 100.

As is apparent from the above description, the oil level gauge of the present invention has the following action and effect by changing a level marker structure having L and F marks for checking a level of oil. Firstly, since the level marker structure is changed in a simplified twisted form, it may be possible to more simply change the structure of the oil level gauge for prevention of oil contamination. Secondly, it may be possible to prevent the oil contamination of the L and F marks when the oil level gauge is pulled out from the engine. Thirdly, it may be possible to maintain the visibility of the L or F mark of the level marker clean without contamination due to oil coated thereon. Fourthly, it may be possible to more accurately determine a time for replenishing oil since the visibility of the L or F mark is secured. Fifthly, there no need for excessive work due to a concern about the oil contamination of the L and F marks when the oil level gauge is pulled out from the engine. Sixthly, it may be possible to improve a consumer quality since it is convenient to maintain the visibility of the oil level gauge and remove the gauge.

While the present invention has been described with respect to the specific exemplary embodiments, it will be apparent to those skilled in the art that various changes and modifications may be made without departing from the spirit and scope of the invention as defined in the following claims.

What is claimed is:

1. An oil level gauge comprising:
a gauge plate having a two-stage twisted section formed for a level mark body connected from a gauge fixture body,
wherein the level mark body has L (LOW) and F (FULL) marks indicative of an oil capacity.

2. The oil level gauge of claim 1, wherein the two-stage twisted section is formed at each of a mark isolation body for connecting the gauge fixture body to the level mark body, and a gauge end body connected to the level mark body.

3. The oil level gauge of claim 2, wherein the mark isolation body and the gauge end body have a phase difference with respect to the gauge fixture body and the level mark body by twisting.

4. The oil level gauge of claim 3, wherein the phase difference is 90°.

5. The oil level gauge of claim 2, wherein the level mark body has a greater length than the mark isolation body and the gauge end body.

6. The oil level gauge of claim 5, wherein a mark isolation section forming the length of the mark isolation body is greater than a gauge end section forming the length of the gauge end body.

7. The oil level gauge of claim 1, wherein the L (LOW) and F (FULL) marks of the level mark body are distinguished by protrusions.

8. The oil level gauge of claim 1, wherein the gauge plate is coupled to a knob gripped by a user's hand, and the knob is coupled with a sealing ring.

9. The oil level gauge of claim 8, wherein the gauge plate is coupled to an engine, and the L (LOW) and F (FULL) marks of the level mark body indicate a level of engine oil.

10. The oil level gauge of claim 9, wherein the engine has a gauge channel path defined by an engine block and a lower crankcase to fit the gauge plate in the gauge channel path.

11. The oil level gauge of claim 7, wherein the L (LOW) and F (FULL) marks include an L mark protrusion and an F mark protrusion which protrude in a hemispheric form from a surface of the level mark body.
